(19) United States
(12) Patent Application Publication
(10) Pub. No.: US 2017/0112119 A1
(43) Pub. Date: Apr. 27, 2017

(54) Baited Animal Trap

(71) Applicants: Raymond Novatney, New Smyrna, FL (US); Robert Roach, Edgewater, FL (US)

(72) Inventors: Raymond Novatney, New Smyrna, FL (US); Robert Roach, Edgewater, FL (US)

(21) Appl. No.: 15/204,099

(22) Filed: Jul. 7, 2016

Related U.S. Application Data
(60) Provisional application No. 62/246,890, filed on Oct. 27, 2015.

(51) Int. Cl. A01M 23/18; A01M 99/00; A01M 23/02

(52) U.S. Cl. CPC A01M 23/18; A01M 23/02; A01M 99/00

(57) ABSTRACT

The present invention provides a baited animal trap that is adapted to trap an animal within its interior after the animal has been attracted therein using bait disposed within a separate bait box along the walls of trap. The trap includes a first end and a second end, whereby a trap door is disposed over the first end and a bait box is provided along the second end. The bait box is a segregated enclosure within the trap or otherwise along its sidewall, whereby the bait box supports food, scent, or other bait therein. The bait box may have a lid or hatch that is accessible through the sidewall of the trap for loading and unloading the same. In one embodiment, the animal trap is a wire cage and utilizes a foot pedal trap release mechanism, which releases the trap door when the animal walks into the trap interior.

### CROSS REFERENCE TO RELATED APPLICATION

This application claims the benefit of U.S. Provisional Application No. 62/246,890 filed on Oct. 27, 2015. The above identified patent application is herein incorporated by reference in its entirety to provide continuity of disclosure.

### BACKGROUND OF THE INVENTION

### Field of the Invention

The present invention relates to animal traps. More specifically, the present invention relates to baited animal traps. In particular, the present invention provides an animal trap with a deployable door, an interior, and a bait box that is filled with animal attractant or food to draw animals into the trap interior.

Those who live in or near wooded areas are accustomed to encounters with wildlife. Wild animals such as raccoons and skunks may eat animal food that is left out for a family pet or may rummage through garbage left outside. Many of these animals are merely a nuisance to homeowners, but some can be threatening to the homeowner or the homeowner's pets. Therefore, it is not uncommon for homeowners to deploy animal traps to capture and remove certain wildlife from the local environment. In addition to protecting one's property, animal traps are deployed to hunt, relocate, or study various animals in the wild.

While various traps exist in the art, many traps are less effective at attracting a particular animal that would be desired. Using bait is a sound method of attracting various animals into a trap, whereby a scented material, food product, or alternative form of animal bait can be placed within the trap to lure a desired animal therein. The present invention provides an animal trap that incorporates a bait box for loading the trap with animal bait in order to improve the likelihood of trapping a desired animal once the trap is set. In addition, the present invention preferably provides an animal trap that minimizes or altogether eliminates causing any harm to the animal in the trapping process.

In particular, the present invention provides a combination humane animal trap and trap with an interior bait box therein. The bait box is a segregated portion of the trap that is loaded with a particular animal bait to attract animals of a particular type into the trap interior. The bait box is disposed along an end of the trap and is partially open to allow scent to disperse therefrom. The bait box may include a lid or hatch that is accessible from the exterior of the trap, while the trap itself is one that has a mechanism that lowers a door over the trap opening to secure the animal therein without causing injury to the animal. Overall, the trap of the present invention improves the art of animal traps and increases the likelihood of attracting a desired animal therein.

### SUMMARY OF THE INVENTION

The following summary is intended solely for the benefit of the reader and is not intended to be limiting in any way. The present invention provides a new baited animal trap that can be utilized for providing convenience for the user when attracting and trapping animals.

It is therefore an object of the present invention to provide a new and improved baited animal trap that has all of the advantages of the prior art and none of the disadvantages.

It is another object of the present invention to provide a baited animal trap that comprises a housing having a first end, a second end, sidewalls, a floor, and an upper surface.

Another object of the present invention is to provide a baited animal trap comprising an animal trap housing forming an interior volume, wherein a trigger mechanism is disposed that actuates a deployable door over the first end of the animal trap to enclose an animal within the interior volume.

Another object of the present invention is to provide a baited animal trap wherein the first end of the animal trap housing comprises an opening with a deployable door that secures thereover, the deployable door being supported along the upper surface of the animal trap housing.

Another object of the present invention is to provide a baited animal trap in which the deployable door has an open state and a closed state. The trigger mechanism is triggered by an animal within the interior of the animal trap housing, in which the trigger mechanism activates the deployable door such that the deployable door moves from the open position to the closed position when the trigger mechanism is triggered.

Another object of the present invention is to provide a baited animal trap comprising in which the animal trap housing further comprising a bait box having an interior volume and a construction that permits scent to emanate therefrom. The bait box has one or more sidewalls that are adapted to allow scent from animal bait to escape therefrom when the animal bait is placed therein.

Another object of the present invention is to provide a baited animal trap comprising in which the bait box has a removable lid for accessing the interior volume thereof.

Another object of the present invention is to provide a baited animal trap wherein the lid of the bait box is disposed along an exterior surface or sidewall of the animal trap housing such that the animal bait can be loaded into the interior volume of the bait box without accessing the interior volume of the animal trap housing.

Another object of the present invention is to provide a baited animal trap wherein the bait box is disposed within the interior volume of the animal trap housing and along the second end thereof.

Another object of the present invention is to provide a baited animal trap wherein the bait box is disposed within the interior volume of the animal trap housing and along the second end thereof, and wherein a first aperture is provided through the upper surface of the animal trap housing that aligns with an opening in the bait box to provide access to the interior volume of the bait box through the upper surface of the animal trap housing. The lid of the bait box is disposed along the upper surface of the animal trap housing and over the first aperture and the opening in the bait box.

Another object of the present invention is to provide a baited animal trap wherein the lid further comprises a latch to secure the lid against an exterior surface of the animal trap housing.

Another object of the present invention is to provide a baited animal trap wherein the bait box is disposed within the interior volume of the animal trap housing and abutting against the upper surface and second end thereof. A first aperture is provided through the upper surface of the animal trap housing that aligns with an opening in the bait box to provide access to the interior volume of the bait box through the upper surface of the animal trap housing. The lid of the bait box is disposed along the upper surface of the animal trap housing and over the first aperture and the opening in the bait box.

Another object of the present invention is to provide a baited animal trap wherein the lid further comprises a latch to secure the lid against an exterior surface of the animal trap housing.

Another object of the present invention is to provide a baited animal trap wherein the deployable door is gravity deployed and the trigger mechanism supports the deployable door in its open state and releases the deployable door when triggered.

Another object of the present invention is to provide a baited animal trap wherein the trigger mechanism further comprises a trip pedal along the floor of the animal trap housing. The trip pedal is pivotably supported and connected to a trip rod extending from the trip pedal and to a rotating arm. The rotating arm has a hook distal end that supports the deployable door in its open position against the upper surface of the animal trap housing. The deployable door is furthermore hingedly affixed to the upper surface of the animal trap housing and along the interior volume thereof. When an animal steps on the trip pedal, the trip pedal rotates and places tension on the trip rod, thereby causing the trip rod to pull and rotate the rotating arm and release the hook distal end thereof from the deployable door. The deployable door then falls into the closed position when released by the hook distal end of the rotating arm.

Another object of the present invention is to provide a baited animal trap wherein the animal trap housing further comprises an open wire construction.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a side view of the baited animal trap of the present invention.

FIG. 2 shows an end view of the baited animal trap of the present invention.

FIG. 3 shows an overhead view of the baited animal trap of the present invention.

FIG. 4 shows a perspective side view of the baited animal trap of the present invention.

FIG. 5 provides a close-up view of an embodiment of the trip mechanism along the upper surface of the animal trap.

### DETAILED DESCRIPTION OF THE INVENTION

Reference is made herein to the attached drawings. Like reference numerals are used throughout the drawings to depict like or similar elements of the baited animal trap of the present invention. For the purposes of presenting a brief and clear description of the present invention, the preferred embodiment will be discussed as used for luring and trapping animals within an animal trap enclosure. The figures are intended for representative purposes only and should not be considered to be limiting in any respect.

The present invention provides an animal trap with a bait box that is adapted to increase the willingness of an animal to enter the trap interior without simply placing bait loosely within the interior of the trap. The animal trap preferably comprises a wire cage and the bait box is preferably a substantially enclosed and rectangular housing within the animal trap interior that can be loaded with various attractants, food, and bait products. The bait box is also preferably disposed within the innermost extent of the trap to induce animals to fully enter the trap to inspect the bait. Finally, the bait box preferably has an open construction that allows animals to interrogate and even eat the bait through the bait box once the animal is within the trap interior. The preferred configuration is but one embodiment of the claimed invention. Several variants and embodiments are contemplated that do not limit the construction of the bait box, trap housing, or trap trigger mechanism. For clarity, the figures show the preferred embodiment.

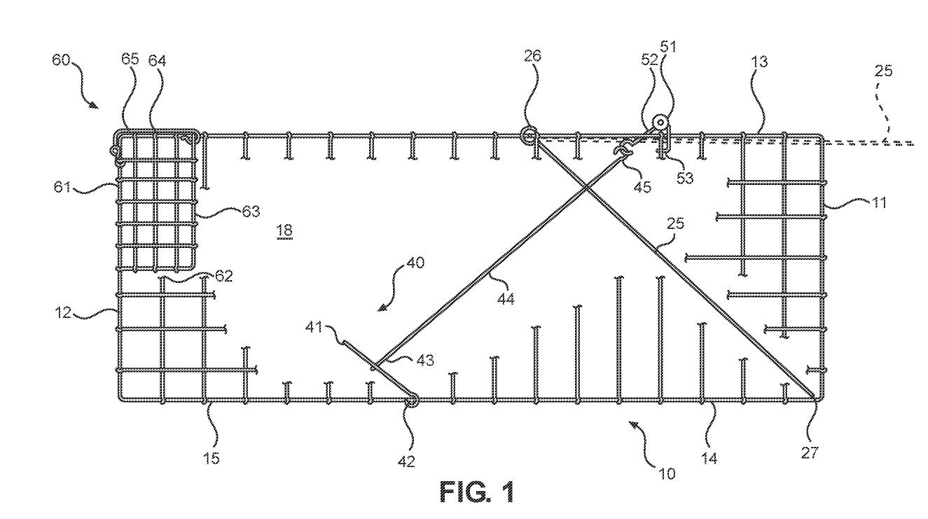

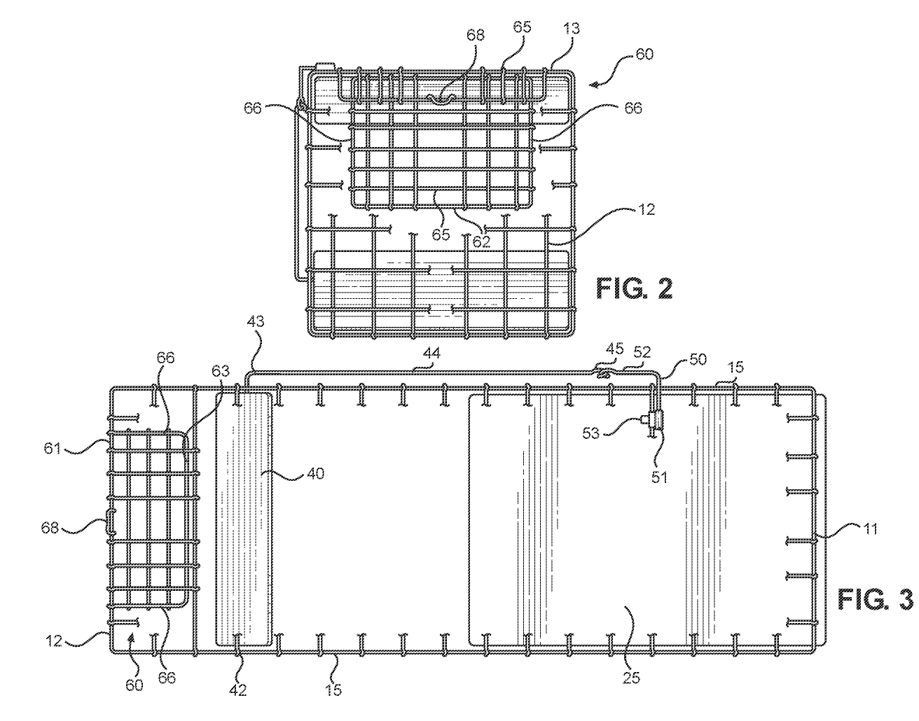

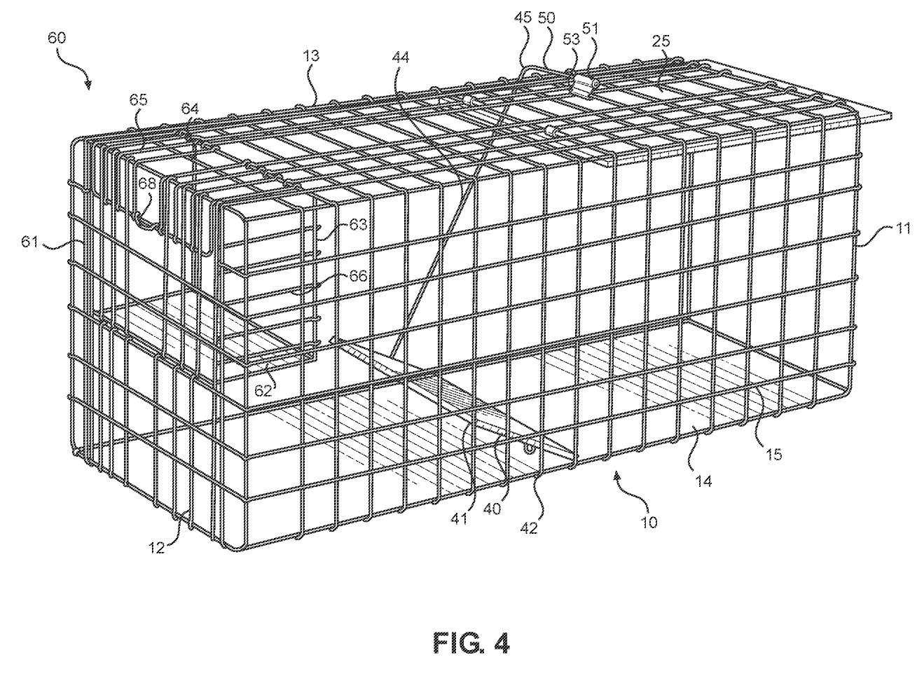

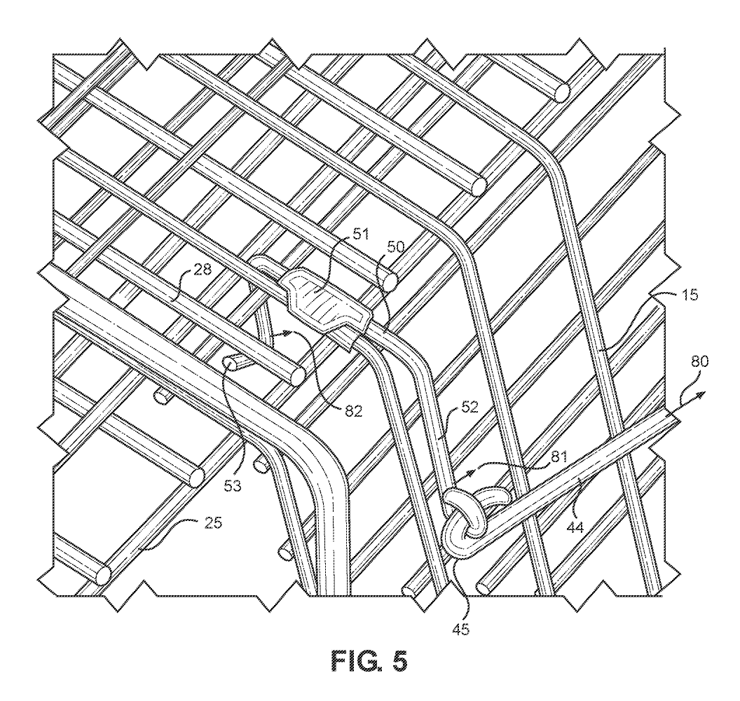

Referring to FIGS. 1-4, there are shown views of the baited animal trap of the present invention from various angles. The animal trap comprises an animal trap housing 10 having a first end 11, a second end 12, sidewalls 15, a floor 14, and an upper surface 13. The animal trap housing 10 also has an open interior volume 18 that is sized to receive a desired animal to be trapped. The first end 11 of the animal trap housing 10 comprises an opening with a deployable door 25 that operably secures thereover when an animal is detected within the interior 18.

A trigger mechanism 40 is used to support the door 25 in an open state and then close the door 25 over the first end 11 of the housing 10 when an animal trips the trigger mechanism 40. The trigger mechanism 40 may take on many forms and include various mechanical or electrical assemblies that cause the door 25 to move from an open position to a closed position when an animal is detected within the housing. The preferred embodiment comprises a mechanical trigger that humanely traps the animal by lowering the door 25 over the first end 11 of the housing 10. This embodiment includes a deployable door 25 that is supported along the upper surface 13 of the animal trap housing and is lowered when the trigger mechanism 40 is activated.

Along one of the sidewalls 15, 12, 13 of the housing is a bait box 60 that is adapted to support animal bait therein. The bait box 60 is an enclosure that allows scent to permeate from its interior to lure animals into the trap interior 18. The bait box 60 may be disposed within the interior 18 of the trap housing 10 or along one of the sides and along the exterior thereof. The preferred location of the bait box 60 is along the second end 12 of the housing 10 and along the upper surface 13 thereof. This positions the bait box 60 within the interior of the housing 10 and a distance inside such that an animal must enter the trap housing 10 from the first end 11 and enter the interior 18 in order to access the contents of the bait box 60. The presence of the animal in the interior 18 activates the trigger mechanism 40 and causes the door 25 to secure over the first end 11 of the housing, trapping the animal in the housing 10.

In a preferred embodiment, the bait box 60 comprises an open wire construction with an interior volume and one or more sidewalls. The sidewalls are adapted to allow scent from animal bait within the bait box 60 to escape therefrom when the animal bait is placed therein. Additionally, the bait box 60 preferably comprises a removable lid 65 for accessing the interior volume thereof. The lid 65 may be provided along any one of the sidewalls of the bait box 60 to allow a user to open the bait box 60, access its interior, and load animal bait therein. After being loaded, the lid 65 is securable using a latch 68 or similar connector that secures the lid 65 to the sidewalls of the bait box 60 or the sidewalls of the trap housing 10.

In some embodiments, the bait box 60 is accessible through one of the sidewalls of the trap housing 10. In particular, the lid 65 of the bait box 60 may be disposed along an exterior surface of the animal trap housing 10 such that the animal bait can be loaded into the interior volume thereof without accessing the interior volume 18 of the animal trap housing 10. Therefore, the opening 64 of the bait box 60 may align with an aperture in the sidewall 15, end wall 12, or upper surface 13 of the trap housing 10 to allow access into the bait box 60 from the exterior of the trap housing 10. This allows easy access thereto if the bait box 60 is disposed towards the second end 12 of the trap housing 10 and within the interior volume 18 thereof.

The bait box 60 may comprise different shapes and dimensions. In one embodiment, the bait box 60 is a substantially rectangular structure with an upper surface, a first end wall 63, a second end wall 61, a lower surface 62, and sidewalls 66. Along one of the surfaces is an opening 64 that is preferably covered by a hinged lid 65.

Furthermore, the opening 64 may align with one of the sidewalls of the trap housing 10. In the preferred configuration and as shown in the drawing views, the bait box 60 is disposed within the interior volume 18 of the animal trap housing 10 and along the second end 12 thereof. A first aperture is provided through the upper surface 13 of the animal trap housing 10 that aligns with an opening 64 in the bait box 60 to provide access to the interior volume of the bait box 60 through the upper surface 13 of the animal trap housing 10. Finally, the lid 65 of the bait box 60 is disposed along the upper surface 13 of the animal trap housing and over the first aperture and the opening 64 in the bait box 60. The lid 65 may also extend over the second end 12 of the trap housing 10 if the bait box 60 is disposed within the upper corner of the trap housing 10 along the second end 12 thereof. The lid 64 includes a latch 68 to secure the lid to the bait box 60 or to the housing 10, whereby the latch may secure an edge of the lid to an exterior surface of the animal trap housing or to the bait box 60 itself.

Once the animal has been lured into the interior 18 of the trap housing 10, the trigger mechanism 40 is activated and the deployable door 25 moves from its open state to its closed state. In a preferred configuration, the deployable door 25 is gravity deployed such that trigger mechanism 40 supports the deployable door 25 in its open state and releases the deployable door 25 when triggered. The trigger mechanism 40 and the manner in which the deployable door 25 closes may take on several forms. It is not desired to limit the trap of the present invention to a specific trigger mechanism, trap housing shape, or door configuration. Rather it is desired to disclose a trap housing with a trigger mechanism, deployable door, and a bait box along the trap housing to lure animals therein. Specific embodiments of the trigger mechanism and door are not meant to be limiting.

In one embodiment, the trigger mechanism 40 comprises a trip pedal 41 along the floor 15 of the animal trap housing 10. The trip pedal 41 is pivotably supported about a pivot point 42 and is connected to one end 43 of a trip rod 44. The trip rod 44 preferably extends along the exterior of the housing 10, whereby the trip rod 44 extends from the trip pedal 41 and to a rotating arm. The upper end 45 of the trip rod 44 comprises a hook distal end that connects to a pivoting door catch 51. The catch 51 is a substantially U-shaped rotating arm with an upper end 50 along the upper surface 13 of the housing, a first member 52 extending along the sidewall 15 of the housing, and a second member 53 comprising a hook end that supports the deployable door 25 when the door 25 is in the open position. The upper end 45 of the trip rod 44 places tension 80 the first member 52 of the catch 51, which rotates 81 the catch along an axis aligned with the upper end 50 thereof. This rotates the hook end of the second member 53, releasing the second member 53 from the deployable door 25 and causing the door to swing down 82 from the upper surface 13 of the housing. The hook end of the second member 53 preferably supports a portion of the wire construction 28 of the door 25 when the door 25 is in the open position. This embodiment of the trigger mechanism 40 therefore utilizes the weight of animal in the trap to release the deployable door 25.

Overall, the animal trap of the present invention comprises a trap housing with an integral bait box 60 therealong or therein. The bait box 60 preferably includes a hingedly attached lid for access, and the lid and walls of the bait box are preferably integral or aligned with the walls of the trap housing 10. The integral embodiment utilizes the walls of the housing as the walls of the bait box 60, with additional walls to enclose the bait box 60 along an internal corner or end of the trap housing. However, the preferred embodiment contemplates separate and distinct walls for the bait box 60 and the housing 10. The construction of both the animal trap housing 10 and the bait box 60 also further comprises an open wire construction, whereby a handle may be positioned along the top of the trap housing for transport. Using an open wire construction lures animals towards the bait box based on scent, and furthermore allows the animal to continue to attempt to eat bait in the bait box once trapped. The device may be constructed using metal wiring or a similar material.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An animal trap having a bait box, comprising:
an animal trap housing having a first end, a second end, sidewalls, a floor, and an upper surface;
the animal trap housing forming an interior volume;
the first end of the animal trap housing comprising an opening with a deployable door that secures thereover, the deployable door being supported along the upper surface of the animal trap housing;
the deployable door having an open state and a closed state;
a trigger mechanism that is triggered by an animal within the interior of the animal trap housing, the trigger mechanism being adapted to activate the deployable door such that the deployable door moves from the open position to the closed position when the trigger mechanism is triggered;
the animal trap housing further comprising a bait box adapted to support animal bait therein;
the bait box having an interior volume and one or more sidewalls that are adapted to allow scent from the animal bait to escape therefrom when the animal bait is placed therein;
the bait box having a removable lid for accessing the interior volume thereof.

2) The animal trap of claim 1, wherein:
the lid of the bait box is disposed along an exterior surface of the animal trap housing such that the animal bait can be loaded into the interior volume of the bait box without accessing the interior volume of the animal trap housing.

3) The animal trap of claim 1, wherein:
the bait box is disposed within the interior volume of the animal trap housing and along the second end thereof.

4) The animal trap of claim 1, wherein:
the bait box is disposed within the interior volume of the animal trap housing and along the second end thereof;
wherein a first aperture is provided through the upper surface of the animal trap housing that aligns with an opening in the bait box to provide access to the interior volume of the bait box through the upper surface of the animal trap housing; and
wherein the lid of the bait box is disposed along the upper surface of the animal trap housing and over the first aperture and the opening in the bait box.

5) The animal trap of claim 4, wherein:
the lid further comprises a latch to secure the lid against an exterior surface of the animal trap housing.

6) The animal trap of claim 1, wherein:
the bait box is disposed within the interior volume of the animal trap housing and abutting against the upper surface and second end thereof;
wherein a first aperture is provided through the upper surface of the animal trap housing that aligns with an opening in the bait box to provide access to the interior volume of the bait box through the upper surface of the animal trap housing; and
wherein the lid of the bait box is disposed along the upper surface of the animal trap housing and over the first aperture and the opening in the bait box.

7) The animal trap of claim 6, wherein:
the lid further comprises a latch to secure the lid against an exterior surface of the animal trap housing.

8) The animal trap of claim 1, wherein the bait box further comprises an open wire construction.

9) The animal trap of claim 1, wherein the deployable door is gravity deployed, whereby the trigger mechanism supports the deployable door in its open state and releases the deployable door when triggered.

10) The animal trap of claim 1, wherein:
the trigger mechanism further comprises a trip pedal along the floor of the animal trap housing;
the trip pedal being pivotably supported and connected to a trip rod;
the trip rod extending from the trip pedal and to a rotating arm;
the rotating arm having a hook distal end that supports the deployable door in its open position against the upper surface of the animal trap housing;
the deployable door being hingedly affixed to the upper surface of the animal trap housing along the interior volume thereof; and
whereby upon an animal stepping on the trip pedal, the trip pedal rotates and places tension on the trip rod, the tension being adapted to rotate the rotating arm and release the hook distal end thereof from the deployable door;
the deployable door falling into the closed position when released by the hook distal end of the rotating arm.

11) The animal trap of claim 1, wherein the animal trap housing further comprises an open wire construction.
